(19) United States
(12) Patent Application Publication
(10) Pub. No.: US 2011/0205980 A1
(43) Pub. Date: Aug. 25, 2011

(54) MULTI-NODE RESOURCE REQUEST PIPELINING

(75) Inventors: Rajat Prakash, La Jolla, CA (US); Rajarshi Gupta, Santa Clara, CA (US); Sai Yiu Duncan Ho, San Diego, CA (US)

(73) Assignee: QUALCOMM INCORPORATED, San Diego, CA (US)

(21) Appl. No.: 12/850,868

(22) Filed: Aug. 5, 2010

Related U.S. Application Data
(60) Provisional application No. 61/232,576, filed on Aug. 10, 2009.

(51) Int. Cl. H04W 72/04

(52) U.S. Cl. 370/329

(57) ABSTRACT

Systems and methodologies are described that facilitate generating anticipatory resource requests for multiple node communications in wireless networks. In a peer-to-peer, ad hoc, relay network, or similar configuration where one node facilitates communicating between a plurality of additional nodes, the node can generate an anticipatory resource request to a serving node. A number of resources can be determined for at least one of the plurality of additional nodes (from the received resource request, one or more communication parameters, a set of granted resources, etc.). The device can generate an anticipatory resource request for communicating to the serving device based on the number of resources. In addition, the anticipatory resource request can be generated based on parameters and/or resource requests from multiple other devices.

### CLAIM OF PRIORITY UNDER 35 U.S.C. §119

The present Application for Patent claims priority to Provisional Application No. 61/232,576 entitled “RELAY RESOURCE REQUEST PIPELINING” filed Aug. 10, 2009, and assigned to the assignee hereof and hereby expressly incorporated by reference herein.

### BACKGROUND

1. Field

The following description relates generally to wireless communications, and more particularly to generating resource requests among multiple nodes.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems may simultaneously support communication for multiple mobile devices. Each mobile device may communicate with one or more access points (e.g., base stations) via transmissions on forward and reverse links. The forward link (or downlink) refers to the communication link from access points to mobile devices, and the reverse link (or uplink) refers to the communication link from mobile devices to access points. Further, communications between mobile devices and access points may be established via single-input single-output (SISO) systems, multiple-input single-output (MISO) systems, multiple-input multiple-output (MIMO) systems, and so forth. Access points, however, can be limited in geographic coverage area as well as resources such that mobile devices near edges of coverage and/or devices in areas of high traffic can experience degraded quality of communications from an access point.

In addition, wireless network communications can occur over multiple wired or wireless nodes. In an example, beyond a mobile device communicating with an access point, one or more mobile devices can communicate in a peer-to-peer communication mode to one or more disparate mobile devices to provide access to the access point, for example, by forwarding communications thereto. In another example, multiple access points can communicate to provide additional functionality and/or increased communication range such that a mobile device can communicate with an access point through another node (e.g., a relay node).

In each configuration, and similar configurations, resources can be separately allocated between the nodes to facilitate communications at each link between each node. In an example, a first node can receive a resource grant from a second node and can transmit data thereover. The second node can then request resources with a third node for forwarding the data from the first node, for example.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with facilitating anticipatorily requesting resource allocation from a serving node in a wireless network based at least in part receiving a resource request from a disparate node in the wireless network. Thus, for example, resource allocation can be requested from the serving node based at least in part on one or more parameters of the resource allocation received from the disparate node without waiting for data to be received over resources granted to the disparate node. Moreover, for example, resource allocation can be requested based at least in part on one or more disparate parameters related to communicating with the disparate node. Thus, delay between receiving data from the disparate node and forwarding the data to the serving node can be mitigated since resources are requested from the serving node upon receiving the resource request from the disparate node and before data is received.

According to related aspects, a method is provided that includes determining a number of resources related to a node in a wireless network and generating an anticipatory request for resources based at least in part on the determining the number of resources related to the node. The method further includes transmitting the anticipatory request for resources to a disparate node in the wireless network.

Another aspect relates to a wireless communications apparatus. The wireless communications apparatus can include at least one processor configured to determine a number of resources related to a node for communicating in a wireless network and create an anticipatory request for resources based at least in part on the number of resources. The at least one processor is further configured to communicate the anticipatory request for resources to a disparate node in the wireless network. The wireless communications apparatus also comprises a memory coupled to the at least one processor.

Yet another aspect relates to an apparatus. The apparatus includes means for determining a number of resources related to a node for communicating in a wireless network. The apparatus also includes means for providing an anticipatory request for resources to a disparate node in the wireless network based at least in part on the number of resources.

Still another aspect relates to a computer program product, which can have a computer-readable medium including code for causing at least one computer to determine a number of resources related to a node in a wireless network and code for causing the at least one computer to create an anticipatory request for resources based at least in part on the number of resources. The computer-readable medium can also comprise code for causing the at least one computer to communicate the anticipatory request for resources to a disparate node in the wireless network.

Moreover, an additional aspect relates to an apparatus including a resource computing component that determines a number of resources related to a node for communicating in a wireless network. The apparatus can further include a resource requesting component that provides an anticipatory request for resources to a disparate node in the wireless network based at least in part on the number of resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed and this description is intended to include all such aspects and their equivalents.

### BRIEF DESCRIPTION OF THE DRAWINGS

FIG. 1 is an illustration of an example wireless communications system that facilitates communicating among multiple wireless network nodes.

FIG. 2 is an illustration of an example communications apparatus for employment within a wireless communications environment.

FIG. 3 is an illustration of an example wireless communication system for generating anticipatory resource requests.

FIG. 4 is an illustration of an example wireless communications system that facilitates creating resource requests based on received resource requests.

FIG. 5 is an illustration of an example wireless communications system that facilitates providing relays for wireless networks.

FIG. 6 is an illustration of an example methodology for generating anticipatory resource requests.

FIG. 7 is an illustration of an example methodology that generates anticipatory resource requests based on parameters for communicating with a node.

FIG. 8 is an illustration of an example methodology for generating anticipatory resource requests based on aggregating parameters for communicating with multiple nodes.

FIG. 9 is an illustration of an example wireless network environment that can be employed in conjunction with the various systems and methods described herein.

FIG. 10 is an illustration of an example system that facilitates generating anticipatory resource requests.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

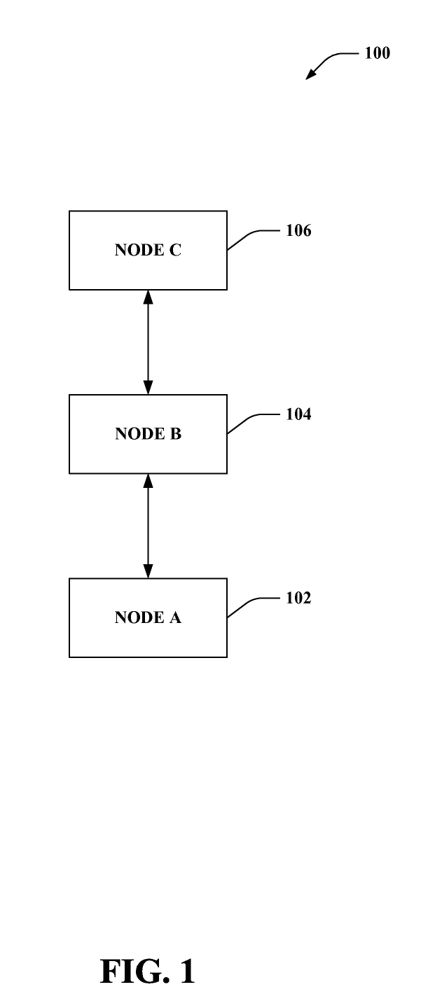

Referring to FIG. 1, a wireless communication system 100 is illustrated that facilitates communicating among various nodes in a wireless network. System 100 includes Node A 102 that communicates with Node B 104, and Node B 104 communicates with Node C 106. In one example, Node B 104 can forward communications from Node A 102 to Node C 106 and/or vice versa. In this regard, for example, Node B 104 can be a relay node, a peer-to-peer or ad hoc communication node with Node C 106 or Node A 102, and/or the like. In one example, Node C 106 can be a donor access point that communicates with one or more core network components (not shown) to provide wireless network access, Node A 102 can be a wireless device, such as a UE, or relay node, and Node B 104 can be a relay node that facilitates communication between the UE and donor access point. Thus, for example, Node A 102, Node B 104, and Node C 106 can each be a mobile device (e.g., a UE, modem, etc.), access point (e.g., macrocell, femtocell, picocell, or similar access point, mobile base station, etc.), relay node, and/or the like.

According to an example, Node B 104 can grant a number of resources to Node A 102 for sending or receiving communications. This can be based, for example, on a request for resources from Node A 102, one or more parameters related to communicating with Node A 102, and/or the like. The request from Node A 102 can include a size of one or more communications for Node B 104 (e.g., a number of resources or bytes), a quality of service (QoS) identifier, and/or the like. Based at least in part on these parameters, for example, Node B 104 can generate an anticipatory resource request to send to Node C 106, which can include similar parameters. The parameters of the anticipatory resource request for Node C 106 can be specified based at least in part on the parameters received in the resource request from Node A 102, for example.

In another example, the parameters for the anticipatory resource request can be generated based at least in part on a number of packets transmitted by Node A 102 that have not yet been received and decoded by Node B 104, resources assigned by Node B 104 to Node A 102 based on the received request, buffer status reports received by Node B 104 from Node A 102, packet patterns related to data expected from Node A 102 (e.g., token buckets assigned to regulate data rate at Node A 102), and/or the like. In addition, Node B 104 can also serve additional nodes (not shown) to provide access to Node C 106. In this example, Node B 104 can also aggregate anticipated resources of a plurality of served nodes in generating an anticipatory resource request to Node C 106. For example, Node B 104 can also determine parameters for the anticipatory request based at least in part on computing a probability of successfully receiving packets transmitted from the plurality of served nodes, the resources assigned by Node B 104 to the plurality of served nodes, buffer status reports for the plurality of served nodes, and/or the like. In yet another example, Node B 104 can generate the anticipatory resource request for Node C 106 per QoS class where Node B 104 aggregates similar QoS requests from the served nodes, and sends a vector of anticipatory resource requests (e.g., one request per QoS), separate requests, and/or the like.

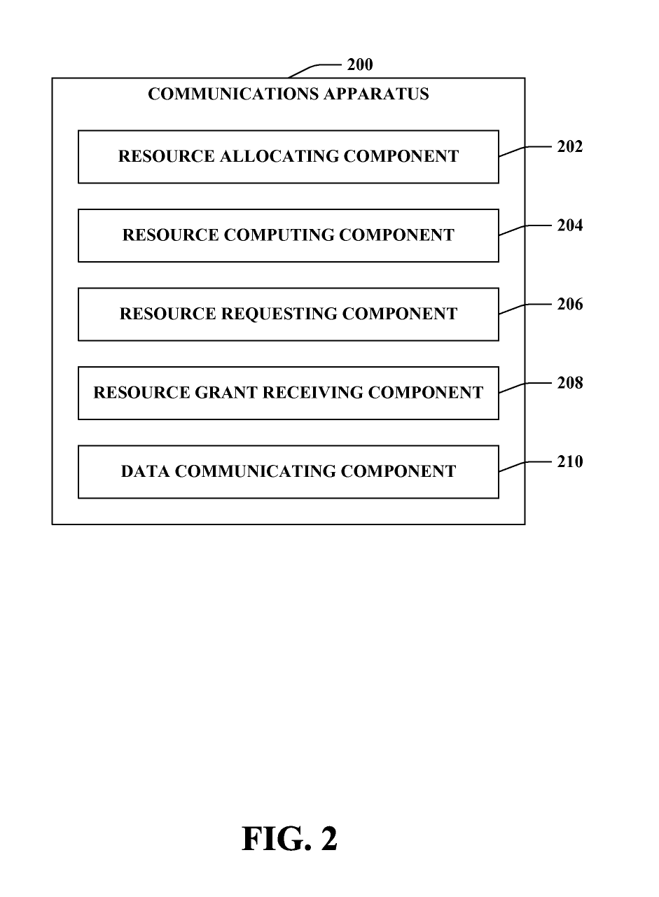

Turning now to FIG. 2, a communications apparatus 200 that can participate in a wireless communications network is illustrated. The communications apparatus 200 can be a mobile device, access point, relay node, a portion thereof, or substantially any device that communicates in a wireless network. Communications apparatus 200 can comprise a resource allocating component 202 that assigns a set of resources to the one or more wireless devices based at least in part on a request for resources or one or more parameters related to communicating with the one or more wireless devices, a resource computing component 204 that determines a number of resources to request from a disparate wireless device (not shown), a resource requesting component 206 that generates a request for the number of communication resources from a disparate wireless device (not shown). Communications apparatus 200 also comprises a resource grant receiving component 208 that obtains resources from the disparate wireless device based on the request and a data communicating component 210 that receives data over the resources assigned to the one or more wireless devices and forwards the data over the resources obtained from the disparate wireless device.

According to an example, resource allocating component 202 can generate a resource allocation for a wireless device. This can be in response to a request for resources received from the wireless device (e.g., over a random access channel (RACH) in LTE), in response to one or more received parameters related to communicating with the wireless device, etc. Where in response to a received request for resources, for example, resource allocating component 202 can generate the resource allocation based at least in part on one or more parameters in the request for resources (e.g., a number of bytes, QoS identifier, buffer status report (BSR), etc.). The resource allocation, in an example, can relate to a set of data resources, which can be shared or dedicated resources (e.g., physical uplink shared channel (PUSCH) resources in LTE). In addition, resource allocating component 202 can transmit the resource allocation over control resources (e.g., a physical downlink control channel (PDCCH) in LTE). Moreover, as described, resource requesting component 206 can generate an anticipatory request for resources from a disparate communications apparatus for forwarding data received over the generated resource allocation. In one example, resource computing component 204 can determine a number of resources for the anticipatory request based at least in part on a received request for resources, the resource allocation generated by resource allocating component 202, one or more received parameters related to communicating with the wireless device, etc.

Thus, for example, resource requesting component 206 can generate the anticipatory request for resources to include similar parameters as in a resource request obtained from the wireless device (e.g., the anticipatory request can have substantially the same parameters, in one example, including the number of bytes, QoS identifier, BSR, etc.). In this example, resource requesting component 206 can communicate the anticipatory request to the disparate communications apparatus, and resource grant receiving component 208 can obtain a grant of a set of resources. Thus, data communicating component 210 can obtain data over the resources assigned by resource allocating component 202 and can forward the data over the set of resources obtained by resource grant receiving component 208 in response to the anticipatory request.

In another example, resource computing component 204 can determine a number of resources for the anticipatory request based on the parameters of the received request for resources, and resource requesting component 206 can request the number of resources from the disparate wireless device. Moreover, in an example, resource requesting component 206 can generate an anticipatory request for resources based at least in part on a size of resource grant created by resource allocating component 202. In addition, for example, resource requesting component 206 can generate an anticipatory request for resources based at least in part on multiple wireless devices. For example, resource requests can be received from multiple devices that each can specify a number of bytes requested, QoS identifier, BSR, and/or the like. Resource computing component 204 can aggregate parameters of the multiple resource requests to determine a number of resources, and resource requesting component 206 can generate an anticipatory request for resources based on the number of resources. Moreover, resource allocating component 202 can generate resource allocations for the multiple devices based at least in part on the received requests for resources. In another example, resource requesting component 206 can create an anticipatory resource request based at least in part on the generated resource allocations. In yet another example, resource computing component 204 can aggregate one or more parameters related to communicating with the multiple devices to determine a number of resources to request, as described herein.

Furthermore, resource requesting component 206 can generate anticipatory resource requests for given QoS classes based at least in part on the one or more received resource requests. Thus, for example, where one or more received resource requests relate to a given QoS identifier, resource computing component 204 can aggregate the related number of bytes (e.g., and/or BSR) for the resource requests related to the given QoS identifier for determining a number of resources to request for each QoS class, and resource requesting component 206 can generate an anticipatory resource request for each QoS class. Where multiple requests are received for multiple QoS classes, resource requesting component 206 can create a vector or structure comprising multiple anticipatory resource requests (e.g., one for each QoS class).

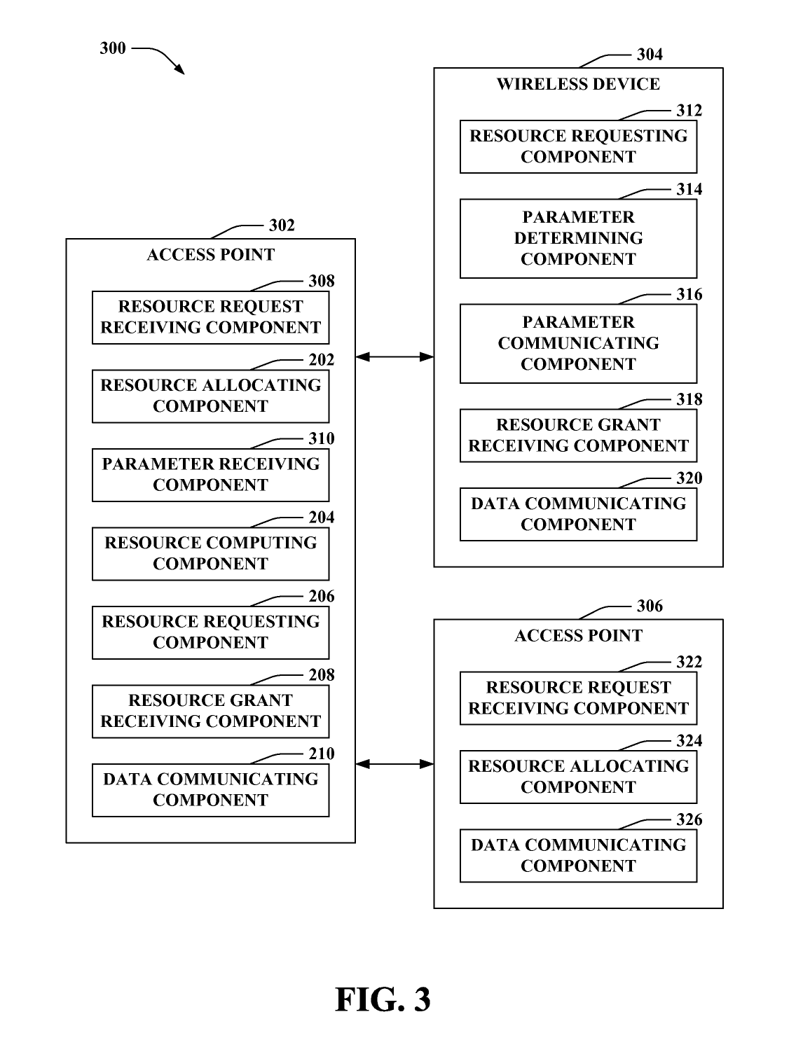

Referring to FIG. 3, an example wireless communication system 300 for generating anticipatory resource requests is illustrated. System 300 includes an access point 302 that provides wireless network access to one or more devices, such as wireless device 304. For example, access point 302 can provide wireless network access through access point 306, which can communicate directly with a core network (not shown), in one example, or other access points. In addition, it is to be appreciated that access point 302 can comprise components of access point 306, and vice versa, to provide similar functionality, in one example. Moreover, access points 302 and 306 can each be a macrocell access point, femtocell access point, picocell access point, mobile base station, and/or the like, which can provide donor access point and/or relay node functionality, as described above. Wireless device 304 can be a UE, modem (or other tethered device), etc. Moreover, as described for example, access point 302 can be a peer device of wireless device 304 communicating therewith in a peer-to-peer or ad hoc mode.

Access point 302 can comprise a resource request receiving component 308 that obtains a resource request from a wireless device, a resource allocating component 202 that assigns a set of resources to the wireless device based at least in part on the resource request, and a parameter receiving component 310 that obtains one or more parameters related to communicating with wireless device 304. Access point 302 additionally comprises a resource computing component 204 that figures a resource allocation size based at least in part on a resource request from the wireless device and/or the one or more parameters, a resource requesting component 206 that creates a request for communication resources from a disparate access point based on the resource allocation size, a resource grant receiving component 208 that obtains resources from the disparate access point based on the request, and a data communicating component 210 that receives data over the resources assigned to the wireless devices and forwards the data to the disparate access point over the obtained resources.

Wireless device 304 comprises a resource requesting component 312 that communicates a request for resources to an access point and a parameter determining component 314 that determines or otherwise obtains one or more parameters related to communicating with one or more access points. Wireless device 304 further comprises a parameter communicating component 316 that transmits the one or more parameters to an access point, a resource grant receiving component 318 that obtains a resource allocation from an access point based at least in part on the request for resources and/or the one or more parameters, and a data communicating component 320 that transmits data to the access point over the resource allocation. Access point 306 comprises a resource request receiving component 322 that obtains a request for resources from one or more access points, a resource allocating component 324 that grants a set of resources to the access point, and a data communicating component 326 that receives wireless device data from the access point over the set of resources.

According to an example, wireless device 304 can request resources from access point 302 for communicating therewith. For example, this can occur as part of an initial connection establishment, handover (e.g., when wireless device 304 moves into range of access point 302), a connection reestablishment, and/or the like. In this regard, resource requesting component 312 can generate a request for resources and can transmit the request to access point 302. For example, resource requesting component 312 can transmit the request over a RACH related to access point 302. Resource request receiving component 308 can obtain the request for resources, and resource allocating component 202 can determine a set of resources to grant to wireless device 304. As described, for example, the request for resources can include a number of bytes requested for communicating data over the resources, a QoS identifier, BSR, etc. Thus, for example, resource allocating component 202 can determine the set of resources based on the number of bytes requested, the QoS identifier, BSR, and/or the like. Resource allocating component 202 can communicate an indication of the set of resources to wireless device 304 (e.g., over a PDCCH or similar control channel), and resource grant receiving component 318 can obtain the set of resources or related indication.

In addition, as described, resource requesting component 206 can generate an anticipatory request for resources from access point 306 based at least in part on the request obtained by resource request receiving component 308 (e.g., based on the number of bytes, QoS identifier, BSR, etc.), the resource grant generated by resource allocating component 202, and/or the like. In one example, resource computing component 204 can calculate a number of resources to request in the anticipatory request (e.g., a number of bytes, which can be indicated in a BSR or otherwise) based at least in part on a number of bytes indicated in the request received from wireless device 304 (e.g., a proportion of the number of bytes indicated in the request from wireless device 304, etc.). As described, the anticipatory request can similarly include a number of bytes requested for communicating with access point 306, a QoS identifier, and/or the like. In one example, resource requesting component 206 can include the number of bytes and QoS identifier of the received request for resources in the anticipatory request for resources. Resource requesting component 206, for example, can communicate the anticipatory request to access point 306. Resource request receiving component 322 can obtain the anticipatory request, and resource allocating component 324 can determine a set of anticipatory resources to grant to access point 302 based at least in part on the anticipatory request (e.g., based on the number of bytes, QoS identifier, etc.).

Resource allocating component 324 can communicate an indication of the set of anticipatory resources to access point 302, and resource grant receiving component 208 can obtain the set of anticipatory resources. At some point, data communicating component 320 can transmit data to access point 302 for providing to access point 306 over the set of resources obtained by resource grant receiving component 318. For example, the set of resources can relate to a PUSCH over which the wireless device 304 can transmit the data. Data communicating component 210 can obtain the data over the set of resources, and if the set of anticipatory resources are received from access point 306 by resource grant receiving component 208, data communicating component 210 can forward the data to access point 306 over the set of anticipatory resources. Data communicating component 326 can obtain and process the data. In addition, in an example, resource computing component 204 can determine a number of resources for the anticipatory request based on a size of the resource allocation generated by resource allocating component 202, as described above.

In another example, parameter determining component 314 can provide one or more communication parameters of wireless device 304 to access point 302. Resource allocating component 202, for instance, can generate a resource allocation for wireless device 304 based at least in part on the one or more communication parameters. In addition, for example, resource computing component 204 can determine the number of resources for the anticipatory request for resources based at least in part on the one or more communication parameters. For example, parameter determining component 314 can obtain a number and/or size of hybrid automatic repeat/request (HARQ) packets at wireless device 304 that have been transmitted but are awaiting receipt and decoding by access point 302 (e.g., parameter determining component 314 can determine that the packets have not been received based on whether HARQ feedback, such as acknowledgement and/or non-acknowledgement, has been received for the packets). Parameter communicating component 316 can transmit the number and/or size of the HARQ packets to access point 302. Parameter receiving component 310 can obtain the number and/or size of the HARQ packets, and resource computing component 204 can determine a number of resources to indicate in the anticipatory resource request based at least in part on the number and/or size of HARQ packets. Thus, for example, where there are a greater number or size of HARQ packets, resource computing component 204 can determine a larger number of resources for the anticipatory resource request. As described above, resource requesting component 206 can generate the anticipatory request indicating the number of resources (e.g., a number of bytes), and can transmit the request to access point 306, which can grant resources, as described, etc.

In another example, resource request receiving component 308 can obtain a BSR related to a number of bytes and/or packets that wireless device 304 has available for transmitting to access point 302 in a request for resources. Parameter communicating component 316 can transmit the BSR to access point 302 in the request for resources. Resource computing component 204, for example, can figure a number of resources to include in the anticipatory resource request based at least in part on the BSR. For example, resource computing component 204 can determine a greater resource size where the BSR indicates that there are packets in the buffer and/or indicate there is a certain number or size of packets in the buffer over a threshold level.

In yet another example, parameter receiving component 310 can obtain or determine one or more parameters regarding a packet pattern expected from wireless device 304. For example, parameter receiving component 310 can obtain one or more token bucket parameters related to token buckets assigned to wireless device 304 to regulate transmissions therefrom. Parameter receiving component 310 can have assigned the token bucket parameters and thus can determine the parameters locally, can receive the token bucket parameters from a core network (e.g., from access point 306), and/or the like. Resource computing component 204 can estimate data available for transmission at wireless device 304 (e.g., a number of packets, size, etc.) based at least in part on the packet pattern parameters and can generate a number of resources to request in the anticipatory resource request based on the estimated data available.

Moreover, for example, parameter receiving component 310 can obtain any of the above parameters related to a number or size of packets that can be expected from multiple wireless devices, including wireless device 304, and resource computing component 204 can aggregate the parameters for the multiple wireless devices to compute a number of resources to request from access point 306. For example, where parameter receiving component 310 obtains HARQ number or size parameters for the multiple wireless devices, resource computing component 204 can add the HARQ number or size parameters to determine a total number or size of packets in corresponding buffers. Resource computing component 204, in one example, computes a number of resources to request from access point 306 to facilitate communicating data in corresponding buffers from the multiple wireless devices. In one example, resource computing component 204 can additionally associate a probability with parameters from the multiple wireless devices. For example, the probability can relate to packets being transmitted from the multiple wireless devices and arriving successfully at access point 302. In this regard, resource computing component 204 can calculate a number of resources to request based on the parameters with corresponding probability applied.

For example, resource computing component 204 can calculate the number of resources based at least in part on the following formula.

p₁*B₁+p₂*B₂ . . .

where p₁ is the probability of receiving packets from wireless device 1, B₁ is a number of bytes for which transmission has begun at wireless device 1 but have not yet been received by access point 302, p₂is the probability of receiving packets from wireless device 2, B₂ is a number of bytes for which transmission has begun at wireless device 2 but have not yet been received by access point 302, and so on. In another example, B₁ and B₂ can respectively be the resources assigned by resource allocating component 202 to wireless device 1 and wireless device 2, etc. Moreover, for example, B₁ and B₂ can respectively be the number of bytes indicated in a BSR for wireless device 1 and wireless device 2, etc. Furthermore, B₁ and B₂ can respectively be substantially any combination of the above parameters related to wireless device 1 and wireless device 2, etc.

Moreover, as described, resource requesting component 206 can generate anticipatory requests for resources related to each QoS class. Thus, for example, resource request receiving component 308 can obtain requests for resources indicating a certain QoS class, as described. Resource computing component 204 can determine a number of resources to request for a given QoS class, as described above. Moreover, in this example, resource requesting component 206 can transmit an anticipatory resource request for the QoS class to access point 306. Resource request receiving component 322 can obtain the anticipatory request for the QoS class, and resource allocating component 324 can assign a set of resources to access point 302 for the QoS class. In addition, for example, resource requesting component 206 can create a vector of anticipatory resource requests for a number of QoS classes and provide the vector to resource request receiving component 322. Resource allocating component 324 can generate resource grants for each of the QoS classes in the vector, in this example.

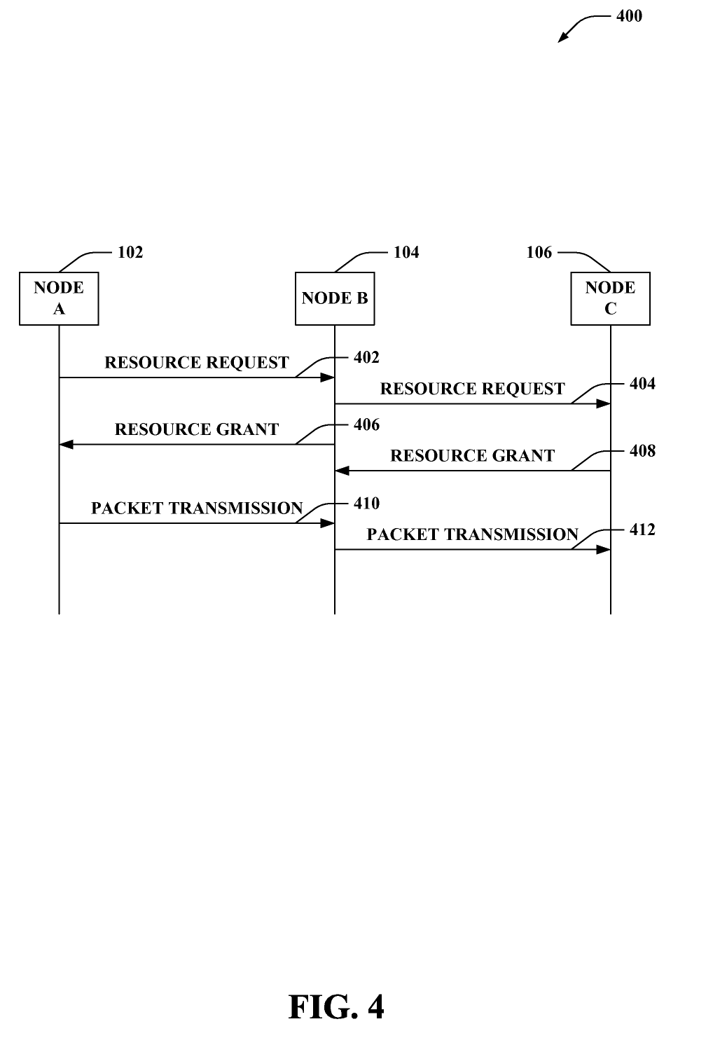

Turning to FIG. 4, an example wireless communication system 400 is illustrated that facilitates transmitting anticipatory resource requests based on one or more disparate received resource requests. In one example, Node C 106 can be a donor access point that communicates with one or more core network components (not shown) to provide wireless network access, Node A 102 can be a wireless device, such as a UE, and Node B 104 can be a relay node that facilitate communication between the UE and donor access point, as described. Thus, for example, Node A 102, Node B 104, and Node C 106 can each be a mobile device (e.g., a UE, modem, etc.), access point (e.g., macrocell, femtocell, picocell, or similar access point, mobile base station, etc.), relay node, and/or the like.

As depicted, Node A 102 can transmit a resource request 402 to Node B 104. As described, Node B 104 can receive resource request 402 from Node A 102 and can generate resource request 404 based at least in part on receiving resource request 402. For example, as described, Node B 104 can generate resource request 404 based at least in part on parameters in the resource request 402, other parameters received (e.g., a number or size of packets transmitted from Node A 102 but not yet received at Node B 104, token bucket parameters, aggregated parameters for multiple nodes communicating with Node B 104, computed probabilities of receiving packets applied to the foregoing parameters, etc., as described), and/or the like. In addition, Node B 104 can transmit a resource grant 406 to Node A 102 based on resource request 402. Node B 104 can additionally generate resource request 404 based on the resource grant 406, in one example.

Node B 104 can transmit resource request 404 to Node C 106 to anticipatorily request resources for Node A 102. It is to be appreciated that resource request 404 can be communicated to Node C 106 following resource grant 406, in another example. Node C 106 can generate a transmit resource grant 408 to Node B 104 based on resource request 404, as described. In addition, it is to be appreciated that resource grant 408 can be received before Node B 104 transmits resource grant 406 to Node A 102, in another example. Once resource grant 406 is received, Node A 102 can provide packet transmission 410 to Node B 104. Node B 104 can forward the packet transmission 412 to Node C 106 once resource grant 408 is received. Thus, Node B 104 anticipatorily requests resources from Node C 106 to serve Node A 102 when a request for resources is received from Node A 102 (e.g., instead of waiting for packet transmission 410) to mitigate delay caused by requesting and receiving resources from Node C 106.

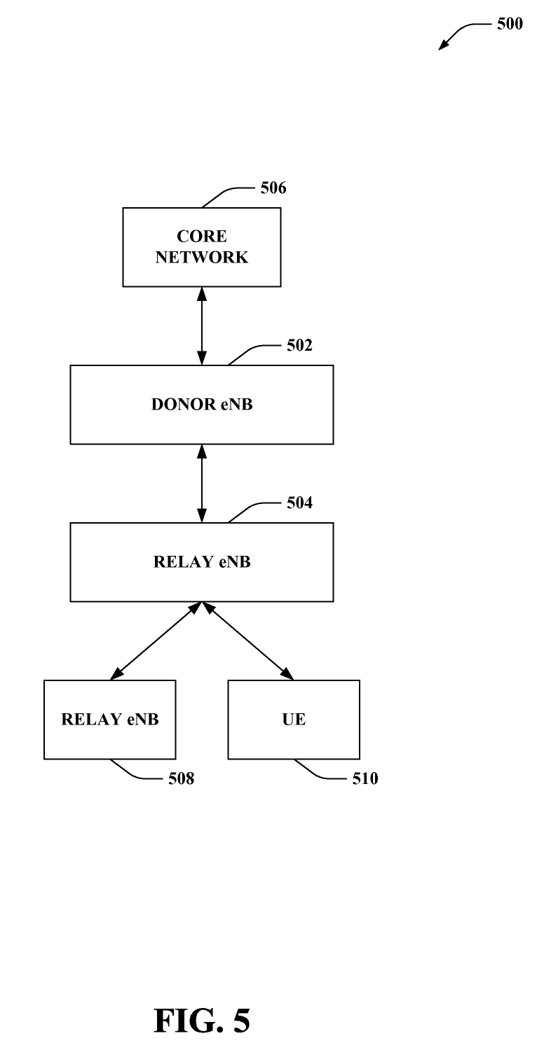

Referring to FIG. 5, a wireless communication system 500 is illustrated that facilitates providing relay functionality in wireless networks. System 500 includes a donor eNB 502 that provides one or more relay eNBs, such as relay eNB 504, with access to a core network 506. Similarly, relay eNB 504 can provide one or more disparate relay eNBs, such as relay eNB 508, or UEs, such as UE 510, with access to the core network 506 via donor eNB 502. Donor eNB 502, which can also be referred to as a cluster eNB, can communicate with the core network 506 over a wired or wireless backhaul link, which can be an LTE or other technology backhaul link. In one example, the core network 506 can be a 3GPP LTE or similar technology network.

Donor eNB 502 can additionally provide an access link for relay eNB 504, which can also be wired or wireless, LTE or other technologies, and the relay eNB 504 can communicate with the donor eNB 502 using a backhaul link over the access link of the donor eNB 502. Relay eNB 504 can similarly provide an access link for relay eNB 508 and/or UE 510, which can be a wired or wireless LTE or other technology link. In one example, donor eNB 502 can provide an LTE access link, to which relay eNB 504 can connect using an LTE backhaul, and relay eNB 504 can provide an LTE access link to relay eNB 508 and/or UE 510. Donor eNB 502 can connect to the core network 506 over a disparate backhaul link technology. Relay eNB 508 and/or UE 510 can connect to the relay eNB 504 using the LTE access link to receive access to core network 506, as described. A donor eNB and connected relay eNBs can be collectively referred to herein as a cluster.

According to an example, relay eNB 504 can connect to a donor eNB 502 at the link layer (e.g., media access control (MAC) layer), transport layer, application layer, and/or the like, as would a UE in conventional LTE configurations. In this regard, donor eNB 502 can act as a conventional LTE eNB requiring no changes at the link layer, transport layer, application layer, etc, or related interface (e.g., user-to-user (Uu), such as E-UTRA-Uu, user-to-network (Un), such as EUTRA-Un, etc.), to support the relay eNB 504. In addition, relay eNB 504 can appear to UE 510 as a conventional eNB in LTE configurations at the link layer, transport layer, application layer, and/or the like, such that no changes are required for UE 510 to connect to relay eNB 504 at the link layer, transport layer, application layer, etc., for example. In addition, relay eNB 504 can configure procedures for resource partitioning between access and backhaul link, interference management, idle mode cell selection for a cluster, and/or the like. It is to be appreciated that relay eNB 504 can connect to additional donor eNBs, in one example.

Thus, for example, relay eNB 504 can establish a connection with donor eNB 502 to receive access to one or more components in core network 506 (such as a mobility management entity (MME), serving gateway (SGW), packet data network (PDN) gateway (PGW), etc.). In an example, UE 510 can request resources from relay eNB 504, which can cause relay eNB 504 to anticipatorily request resources from donor eNB 502 for UE 510 communications, as described above. For example, relay eNB 504 can generate an anticipatory resource request based on the request from UE 510, a corresponding grant to UE 510, one or more parameters regarding communicating with UE 510 (e.g., token bucket parameters, etc.), aggregated parameters regarding communicating with a plurality of UEs, and/or the like. In addition, as described, the anticipatory request can be a vector of anticipatory requests each for given QoS classes, and/or the like.

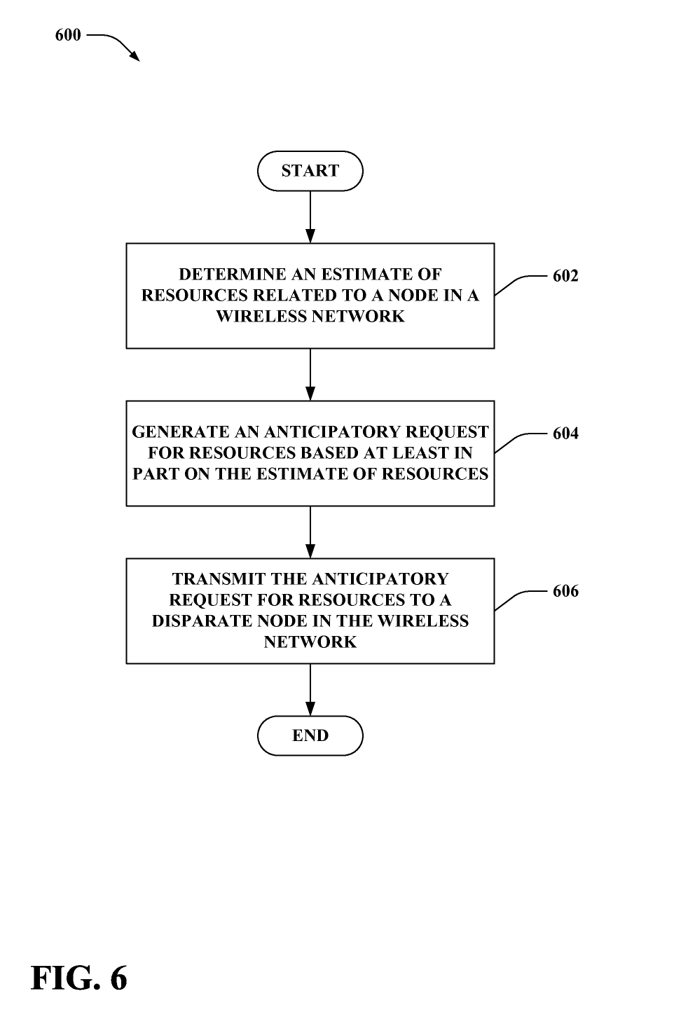

Referring to FIGS. 6-8, methodologies relating to generating anticipatory resource requests are illustrated. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Turning to FIG. 6, an example methodology 600 that facilitates generating anticipatory resource requests is illustrated. At 602, an estimate of resources related to a node in a wireless network can be determined. As described, the estimate of resources can be based at least in part on a received request for resources (or one or more parameters thereof), a set of resources allocated to the node, one or more parameters related to communicating with the node, and/or the like. At 604, an anticipatory request for resources can be generated based at least in part on the estimate of resources. In one example, as described, the anticipatory resource request can be generated to include a number of resources requested based on the number of resources or bytes, QoS identifier, etc., in a received request for resources.

In addition, for example, the anticipatory request can be generated based at least in part on one or more parameters related to communicating with the node, which can be received therefrom (such as a number of HARQ packets transmitted therefrom that are awaiting receipt or decoding, and/or the like), determined based on communications therewith (such as an expected packet pattern), etc. Moreover, the anticipatory resource request can relate to aggregated parameters of multiple nodes, aggregated parameters combined with a probability of receiving packets from the multiple nodes, and/or the like. In another example, the anticipatory resource request can relate to a resource allocation generated for the node. At 606, the anticipatory request for resources can be transmitted to a disparate node in the wireless network. This can mitigate delay for subsequent transmissions that can be caused by requesting the resources from the disparate node.

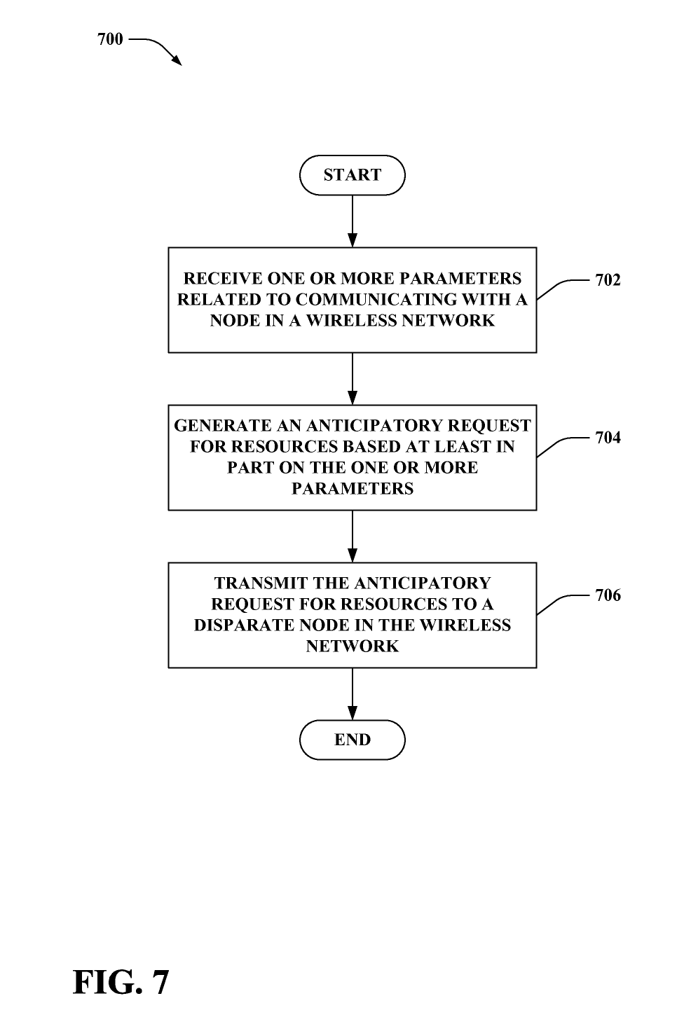

Referring to FIG. 7, an example methodology 700 is depicted that facilitates generating an anticipatory resource request based at least in part on one or more parameters related to communicating with a wireless network node. At 702, one or more parameters related to communicating with a node in a wireless network can be received. The one or more parameters can be received from the node, determined based on communicating with the node, and/or the like. For example, the one or more parameters can include a number or size of HARQ packets transmitted by the node that are awaiting receipt and decoding at a disparate node, one or more token buckets for the node, and/or the like, as described. In addition, the one or more parameters can be received as part of the request for resources and can relate to a number of bytes requested, a QoS identifier, BSR, and/or the like. At 704, an anticipatory request for resource can be generated based at least in part on the one or more parameters. At 706, the anticipatory request for resources can be transmitted to a disparate node in the wireless network. In addition, it is to be appreciated that a set of resources can be allocated to the node based on the one or more parameters, as described in one example.

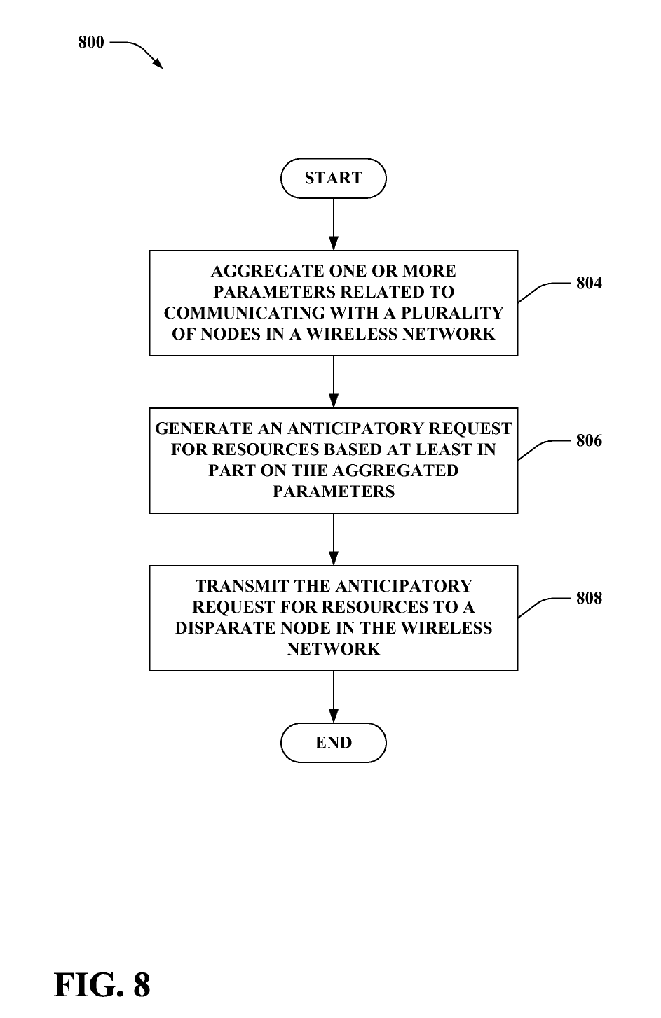

Turning to FIG. 8, an example methodology 800 that facilitates generating an anticipatory resource request based on aggregated parameters of one or more nodes requesting resources is illustrated. At 802, one or more parameters related to communicating with a plurality of nodes in a wireless network can be aggregated. In one example, the one or more parameters can be received in requests for resources from the plurality of nodes. In another example, the one or more parameters can be determined based on communicating with the nodes, and/or the like. This can include, for instance, applying a probability that packets will be received from a given node to the one or more parameters related to that node, as described. At 804, an anticipatory request for resources can be generated based at least in part on the aggregated parameters. In an example, as described, this can include generating a vector of anticipatory requests for resources each relating to a different QoS class specified in requests for resources received from the plurality of nodes, as described. At 806, the anticipatory request for resources can be transmitted to a disparate node in the wireless network.

It will be appreciated that, in accordance with one or more aspects described herein, inferences can be made regarding computing a number of resources to request in an anticipatory resource request, and/or other aspects described herein. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

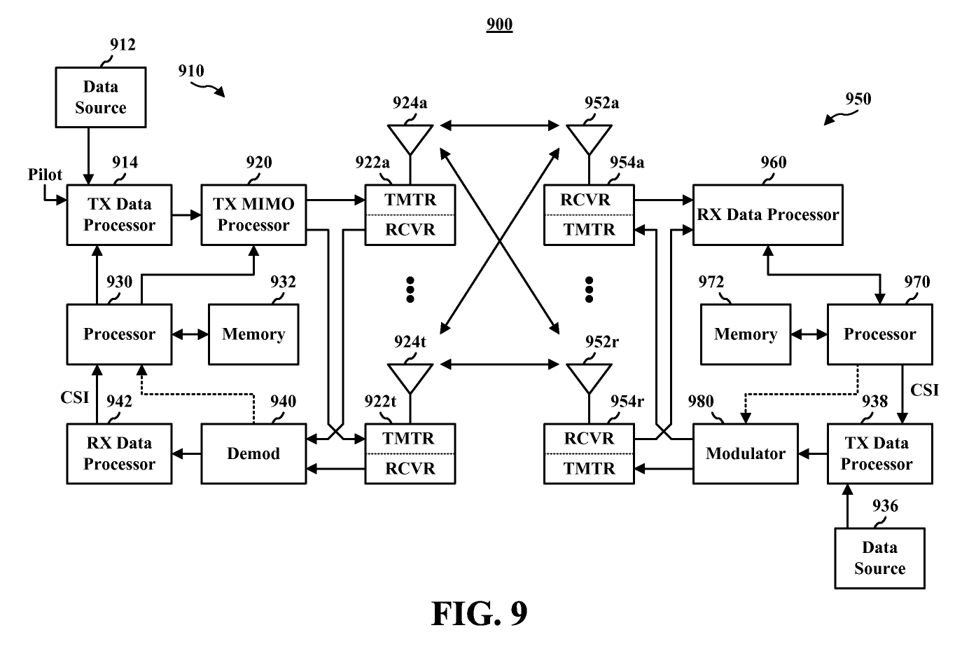

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-5) and/or methods (FIGS. 6-8) described herein to facilitate wireless communication therebetween.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various aspects, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 can periodically determine which precoding matrix to utilize as discussed above. Further, processor 970 can formulate a reverse link message comprising a matrix index portion and a rank value portion.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g., control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

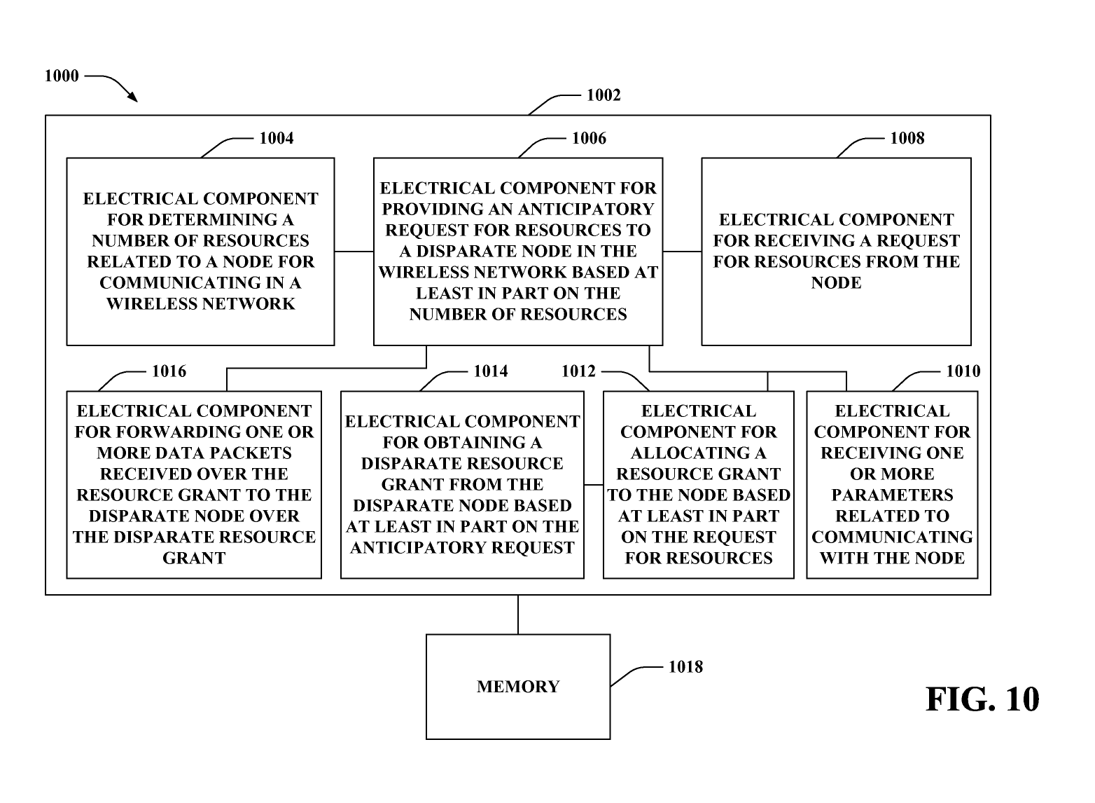

With reference to FIG. 10, illustrated is a system 1000 that facilitates generating anticipatory requests for resources. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For instance, logical grouping 1002 can include an electrical component for determining a number of resources related to a node for communicating in a wireless network 1004. For example, as described, electrical component 1004 can determine the number of resources based at least in part on a received request for resources, a set of resources allocated to the node, one or more parameter related to communicating with the node, and/or the like. For example, electrical component 1004 can determine the number of resources based at least in part on a number of HARQ packets transmitted from the node that are awaiting receipt or decoding, packet pattern parameters, aggregated parameters of multiple nodes, aggregated parameters combined with a probability of receiving packets from the multiple nodes, the resource grant provided to the node, etc.

Additionally, logical grouping 1002 can include an electrical component for providing an anticipatory request for resources to a disparate node in the wireless network based at least in part on the number of resources 1006. As described, the anticipatory request for resources can allow establish resources with the disparate node for forwarding communications from the node upon receipt. Moreover, logical grouping 1002 can include an electrical component for receiving a request for resources from the node 1008. As described, in one example, electrical component 1004 can utilize one or more parameters from the request (such as a number of bytes, QoS identifier, BSR, etc.) to determine the number of resources. In addition, logical grouping 1002 can include an electrical component for receiving one or more parameters related to communicating with the node 1010. As described above, electrical component 1004 can determine the number of resources based on the one or more parameters as well. Also, as described, electrical component 1006 can utilize the number resources in the anticipatory request for resources.

Furthermore, logical grouping 1002 can include an electrical component for allocating a resource grant to the node based at least in part on the request for resources 1012. As described, for example, the resource grant can relate to resources for communicating data with the node, and can be used by electrical component 1004 to determine the number of resources. In addition, logical grouping 1002 can include an electrical component for obtaining a disparate resource grant from the disparate node based at least in part on the anticipatory request 1014, and an electrical component for forwarding one or more data packets received over the resource grant to the disparate node over the disparate resource grant 1016. Additionally, system 1000 can include a memory 1018 that retains instructions for executing functions associated with electrical components 1004, 1006, 1008, 1010, 1012, 1014, and 1016. While shown as being external to memory 1018, it is to be understood that one or more of electrical components 1004, 1006, 1008, 1010, 1012, 1014, and 1016 can exist within memory 1018.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions, procedures, etc. may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or aspects may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method, comprising:
determining a number of resources related to a node in a wireless network;
generating an anticipatory request for resources based at least in part on the determining the number of resources related to the node; and
transmitting the anticipatory request for resources to a disparate node in the wireless network.

2. The method of claim 1, further comprising receiving a request for resources from the node, wherein the determining the number of resources is based at least in part on the request for resources.

3. The method of claim 2, wherein determining the number of resources is based at least in part on one or more parameters in the request for resources.

4. The method of claim 3, wherein the one or more parameters include a number of bytes requested or a quality of service identifier.

5. The method of claim 3, wherein the one or more parameters include a buffer status report related to one or more buffers comprising one or more packets for transmission at the node.

6. The method of claim 1, further comprising:
creating a resource grant for the node based at least in part on the number of resources; and
transmitting the resource grant to the node.

7. The method of claim 6, wherein the generating the anticipatory request for resources is based at least in part on the resource grant.

8. The method of claim 1, further comprising computing a disparate number of resources for the anticipatory request for resources, wherein the generating the anticipatory request for resources comprises including the disparate number of resources in the anticipatory request for resources.

9. The method of claim 8, further comprising determining a number or size of hybrid automatic repeat/request (HARQ) packets transmitted from the node that are awaiting receipt or decoding, wherein the computing the disparate number of resources for the anticipatory request for resources is based at least in part on the number or size of HARQ packets.

10. The method of claim 8, further comprising determining one or more parameters of a packet pattern related to the node, wherein the computing the disparate number of resources for the anticipatory request for resources is based at least in part on the one or more parameters.

11. The method of claim 10, wherein the determining the one or more parameters of the packet pattern includes determining one or more token buckets assigned to the node.

12. The method of claim 8, further comprising receiving one or more disparate requests for resources from one or more additional nodes in the wireless network, wherein the computing the disparate number of resources for the anticipatory request for resources includes aggregating one or more parameters related to communicating with the one or more additional nodes.

13. The method of claim 12, wherein the aggregating one or more parameters related to communicating with the one or more additional nodes includes aggregating one or more disparate parameters in the one or more disparate requests for resources, aggregating a number or size of hybrid automatic repeat/request (HARQ) packets transmitted by the one or more additional nodes that are awaiting receipt or decoding, aggregating additional numbers of resources assigned to the one or more additional nodes, aggregating buffer status reports from the one or more additional nodes, or aggregating one or more token bucket parameters related to the one or more additional nodes.

14. The method of claim 12, wherein the computing the disparate number of resources for the anticipatory request for resources further includes applying a probability to each of the one or more parameters related to communicating with the one or more additional nodes.

15. The method of claim 12, wherein the aggregating one or more parameters includes aggregating the one or more parameters related to communicating with the one or more additional nodes according to a quality of service related to the one or more parameters.

16. The method of claim 15, wherein the generating the anticipatory request for resources includes generating a vector of anticipatory requests each corresponding to the quality of service related to the one or more parameters.

17. The method of claim 1, wherein the node is a user equipment and the disparate node is a donor access point in a third generation partnership project long term evolution network.

18. A wireless communications apparatus, comprising:
at least one processor configured to:
determine a number of resources related to a node for communicating in a wireless network;
create an anticipatory request for resources based at least in part on the number of resources; and
communicate the anticipatory request for resources to a disparate node in the wireless network; and
a memory coupled to the at least one processor.

19. The wireless communications apparatus of claim 18, wherein the at least one processor is further configured to receive a request for resources from the node, and the at least one processor determines the number of resources based at least in part on the request for resources.

20. The wireless communications apparatus of claim 19, wherein the at least one processor creates the anticipatory request for resources based at least in part on one or more parameters in the request for resources.

21. The wireless communications apparatus of claim 18, wherein the at least one processor is further configured to generate a resource grant for the node based at least in part on the number of resources and transmit the resource grant to the node.

22. The wireless communications apparatus of claim 21, wherein the at least one processor creates the anticipatory request for resources based at least in part on the resource grant.

23. The wireless communications apparatus of claim 18, wherein the at least one processor is further configured to compute a disparate number of resources included in the anticipatory request for resources.

24. The wireless communications apparatus of claim 23, wherein the at least one processor is further configured to receive one or more parameters related to communicating with the node, and the at least one processor computes the disparate number of resources based at least in part on the one or more parameters.

25. The wireless communications apparatus of claim 24, wherein the one or more parameters includes a number or size of hybrid automatic repeat/request packets transmitted by the node that are awaiting receipt or decoding by the wireless communications apparatus, or an assigned packet pattern related to the node.

26. The wireless communications apparatus of claim 18, wherein the at least one processor is further configured to obtain one or more disparate requests for resources from one or more additional nodes in the wireless network, and the at least one processor creates the anticipatory request for resources based at least in part on aggregating one or more parameters related to communicating with the one or more additional nodes.

27. An apparatus, comprising:
means for determining a number of resources related to a node for communicating in a wireless network; and
means for providing an anticipatory request for resources to a disparate node in the wireless network based at least in part on the number of resources.

28. The apparatus of claim 27, further comprising means for receiving a request for resources from the node, wherein the means for determining determines the number of resources based at least in part on the request for resources.

29. The apparatus of claim 28, wherein the means for providing generates the anticipatory request for resources based at least in part on one or more parameters in the request for resources.

30. The apparatus of claim 27, further comprising means for allocating a resource grant to the node based at least in part on the number of resources.

31. The apparatus of claim 30, wherein the means for providing generates the anticipatory request for resources based at least in part on the resource grant.

32. The apparatus of claim 30, further comprising:
means for obtaining a disparate resource grant from the disparate node based at least in part on the anticipatory request; and
means for forwarding one or more data packets received over the resource grant to the disparate node over the disparate resource grant.

33. The apparatus of claim 27, further comprising means for receiving one or more parameters related to communicating with the node, wherein the means for determining determines the number of resources based at least in part on the one or more parameters related to communicating with the node, and the means for providing generates the anticipatory request for resources based at least in part on the one or more parameters.

34. The apparatus of claim 33, wherein the one or more parameters include a number or size of hybrid automatic repeat/request packets transmitted by the node that are awaiting receipt or decoding, or a packet pattern related to the node.

35. A computer program product, comprising:
a computer-readable medium comprising:
code for causing at least one computer to determine a number of resources related to a node in a wireless network;
code for causing the at least one computer to create an anticipatory request for resources based at least in part on the number of resources; and
code for causing the at least one computer to communicate the anticipatory request for resources to a disparate node in the wireless network.

36. The computer program product of claim 35, wherein the computer-readable medium further comprises code for causing the at least one computer to receive a request for resources from the node, and the code for causing the at least one computer to determine determines the number of resources based at least in part on the request for resources.

37. The computer program product of claim 36, wherein the code for causing the at least one computer to create creates the anticipatory request for resources based at least in part on one or more parameters in the request for resources.

38. The computer program product of claim 35, wherein the computer-readable medium further comprises code for causing the at least one computer to generate a resource grant for the node based at least in part on the number of resources and transmit the resource grant to the node.

39. The computer program product of claim 38, wherein the code for causing the at least one computer to create creates the anticipatory request for resources based at least in part on the resource grant.

40. The computer program product of claim 35, wherein the computer-readable medium further comprises code for causing the at least one computer to compute a disparate number of resources included in the anticipatory request for resources.

41. The computer program product of claim 40, wherein the computer-readable medium further comprises code for causing the at least one computer to receive one or more parameters related to communicating with the node, and the code for causing the at least one computer to compute computes the disparate number of resources based at least in part on the one or more parameters.

42. The computer program product of claim 41, wherein the one or more parameters include a number or size of hybrid automatic repeat/request packets transmitted by the node that are awaiting receipt or decoding, or one or more token buckets assigned to the node.

43. The computer program product of claim 35, wherein the computer-readable medium further comprises code for causing the at least one computer to obtain one or more disparate requests for resources from one or more additional nodes in the wireless network, and the code for causing the at least one computer to create creates the anticipatory request for resources based at least in part on aggregating one or more parameters related to communicating with the one or more additional nodes.

44. An apparatus, comprising:
a resource computing component that determines a number of resources related to a node for communicating in a wireless network;
a resource requesting component that provides an anticipatory request for resources to a disparate node in the wireless network based at least in part on the number of resources.

45. The apparatus of claim 44, further comprising a resource request receiving component that obtains a request for resources from the node, wherein the resource computing component determines the number of resources based at least in part on the request for resources.

46. The apparatus of claim 45, wherein the resource requesting component generates the anticipatory request for resources based at least in part on one or more parameters in the request for resources.

47. The apparatus of claim 44, further comprising a resource allocating component that provides a resource grant to the node based at least in part on the number of resources.

48. The apparatus of claim 47, wherein the resource requesting component generates the anticipatory request for resources based at least in part on the resource grant.

49. The apparatus of claim 47, further comprising:
a resource grant receiving component that obtains a disparate resource grant from the disparate node based at least in part on the anticipatory request; and
a data communicating component that forwards one or more data packets received over the resource grant to the disparate node over the disparate resource grant.

50. The apparatus of claim 44, further comprising a parameter receiving component that obtains one or more parameters related to communicating with the node, wherein the resource computing component determines the number of resources for the anticipatory request for resources based at least in part on the one or more parameters, and the resource requesting component generates the anticipatory request for resources based at least in part on the one or more parameters.

51. The apparatus of claim 50, wherein the one or more parameters include a number or size of hybrid automatic repeat/request packets transmitted by the node that are awaiting receipt or decoding, or one or more packet pattern parameters related to data expected from the node.
